(19) United States
(12) Patent Application Publication
(10) Pub. No.: US 2026/0146910 A1
(43) Pub. Date: May 28, 2026

(54) INTEGRATION OF FIBER OPTICS AND RAREFACTION WAVE FOR PIPELINE LEAK QUANTIFICATION

(71) Applicant: Cameron International Corporation, Houston, TX (US)

(72) Inventors: Kang Wang, Houston, TX (US); Shu Pan, Calgary (CA); Taoufik Wassar, Houston, TX (US); Nasser Ghorbani, Houston, TX (US); Parag Vasant Karanjkar, Katy, TX (US); Adnan Chughtai, Houston, TX (US)

(21) Appl. No.: 19/178,073

(22) Filed: Apr. 14, 2025

Related U.S. Application Data
(60) Provisional application No. 63/645,698, filed on May 10, 2024.

(51) Int. Cl. G01M 3/28; G01M 3/24

(52) U.S. Cl. CPC G01M 3/2815; G01M 3/243

(57) ABSTRACT

A system may include a processor, a memory, and instructions stored on the memory and executable by the processor to receive, from a fiber optic cable extending along a fluid conduit, an indication of a leak event, and receive, from one or more sensors, measured pressure values of a fluid flow along the conduit. Additionally, the processor may determine one or more estimated time stamps associated with one or more expected pressure changes at one or more locations along the fluid conduit based on the indication of the leak event and a rarefaction wave model, compare the measured pressure values from the one or more sensors to expected pressure values at the one or more locations along the fluid conduit to verify the one or more estimated time stamps, and generate a notification based on the comparison of the measured pressure values and the expected pressure values.

### CROSS-REFERENCE TO RELATED APPLICATION

This application claims priority to and the benefit of U.S. Provisional Patent Application No. 63/645,698, entitled “INTEGRATION OF FIBER OPTICS AND RAREFACTION WAVE FOR PIPELINE LEAK QUANTIFICATION,” filed on May 10, 2024, which is hereby incorporated by reference in its entirety for all purposes.

### BACKGROUND

The present disclosure generally relates generally to quantification of pipeline leaks, and more particularly to integration of fiber optics and rarefaction wave for pipeline leak quantification.

Oil and gas pipeline networks are generally considered the most economical and safest means of transporting crude oil with high efficiency and reliability. Pipeline leak events may cause damage to the environment and financial loss (e.g., loss of product, cost of cleanup and maintenance, and the like). The impact of pipeline leak events may increase when a pipeline leak event is not detected promptly. Accordingly, new methods for pipeline leakage detection and quantification may be desirable.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In some configurations, a method includes detecting a leak event using fiber optic sensing, and cross-validating the leak event using rarefaction wave.

In some configurations, a method includes detecting a leak event using fiber optic sensing, feeding a location and a time of the leak event into a rarefaction wave model, and cross-validating the leak event.

Cross-validating the leak event can include classifying the event. Classifying the event may include confirming a leak, suppressing a false alarm, and/or interactive pressure/derivative validation. The method can include estimating leak rate and size.

In certain embodiments, a processor, a memory, and instructions stored on the memory and executable by the processor to receive an indication of a leak event from a fiber optic cable extending along a fluid conduit, receive measured pressure values of a fluid flow along the conduit from one or more sensors, determine one or more estimated time stamps associated with one or more expected pressure changes at one or more locations along the fluid conduit based on the indication of the leak event and a rarefaction wave model, compare the measured pressure values from the one or more sensors to expected pressure values at the one or more locations along the fluid conduit to verify the one or more estimated time stamps, and generate a notification based on the comparison of the measured pressure values and the expected pressure values.

In certain embodiments, a method includes detecting one or more parameters of a leak event via a fiber optic cable extending along a fluid conduit and determining an estimated time stamp associated with an expected pressure change for one or more locations along the fluid conduit based on the one or more parameters and a rarefaction wave model. The method may also include receiving one or more measured pressure values at the one or more locations along the fluid conduit, determining whether the expected pressure change occurs at the estimated time stamp for each of the one or more locations by comparing the one or more measured pressure values.

In certain embodiments, a non-transitory, tangible, computer readable medium having instructions that, when executed by a processor, causes the processor to perform operations including determining one or more parameters of a leak event via a fiber optic cable extending along a fluid conduit, and determining an estimated time stamp associated with an expected pressure change for one or more locations along the fluid conduit within a threshold distance from the leak event based on the one or more parameters and a rarefaction wave model. The operations further include determining whether the expected pressure change occurs at the estimated time stamp for each of the one or more locations along the fluid conduit based on a comparison between one or more measured pressure values at the one or more locations to one or more expected pressure values at the one or more locations, and generating a notification indicative of one or more characteristics of the leak event based on the comparison between the one or more measured values at the one or more locations to the one or more expected pressure values at the one or more locations.

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an example pipeline system;

FIG. 2 is a schematic view of an example pipeline monitoring system that could be used in the pipeline system of FIG. 1, according to an embodiment of the present disclosure;

FIG. 3 is a block diagram of an example process for integrating fiber optics and pressure measurements, according to an embodiment of the present disclosure;

FIG. 4 is a graph of rarefaction wave magnitude vs. distance from leak site with a range of nominal flow leak rates;

FIG. 5 is a graph of an example of pressure drop behavior;

FIG. 6 is a graph of an example of a regression method to estimate the pressure drop at various distances from a leak site; and

FIG. 7 is a flow chart of a workflow for detecting and quantifying a pipeline leak using an integration of fiber optics and rarefaction wave, according to an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Substantial research efforts have been devoted to developing and implementing various approaches for oil and gas pipeline leak detection and localization. Two specific approaches are fiber optics sensing and rarefaction wave.

Remote fiber optic sensing technologies are routinely used to mitigate leak events or identify leak location, such that operators may swiftly take data-driven action to minimize the severity of the respective leak event. This technology requires installation of fiber optic sensors along the exterior of a respective pipeline. For example, fiber optic sensors may be embedded or placed in close proximity to a material that is affected by the presence of a fluid (e.g., water, oil, gas, etc.), such as any suitable polymer, metal, ceramic, gel, or combination thereof, and the like. The material may be applied as a coating to the fiber optic sensors, and may undergo a change such as swelling, shrinking, dissolving, or any other suitable reaction in response to the presence of the fluid. The change in the material may affect the fiber optic sensors by increasing or reducing strain on the fiber, or by causing a chemical reaction with the fiber. Accordingly, when pipeline leakage occurs and hydrocarbon fluid affects the coating material, the fiber optic sensors may detect acoustic and temperature anomalies associated with the leak. Fiber optic sensing is universally applicable to above-ground gathering networks, buried transcontinental oil and gas transmission pipelines, and suitable for all fluid types.

Rarefaction wave, also referred to as acoustic, negative pressure, or expansion wave, is a leak detection method based on an analysis of pipeline pressure variations. For example, when a leak event occurs (e.g., when a leak breaches a pipeline wall) a sudden pressure drop at the location of the leak event may occur, followed by a rapid re-pressurization. As a result, a low-pressure expansion wave may travel at the speed of sound through the hydrocarbon fluid, propagating from the leak in both directions (e.g., upstream and downstream from the leak) and traveling through or past one or more field instruments (e.g., pressure stations, pressure sensors) at various positions along the pipeline (e.g., at 30 to 50-kilometer intervals, at the inlet and outlets of pipeline components, etc.), and thus at various distances away from the leak. Pressure measurements and any other suitable data gathered across a predicted time interval at each end of a monitored section of the pipeline (e.g., from two pressure stations spaced 50-kilometers away from each other) may be used to calculate the location of the leak event. That is, a leak location may be determined by comparing measured pressure values at specific times and various locations along the pipeline to expected pressure values associated with a leak event according to speed of sound calculations. Since the rarefaction wave travels at speeds in the order of one mile per second, rarefaction wave leak detection methods may be particularly successful at quickly detecting large, sudden leaks. Conversely, rarefaction wave leak detection methods may take longer to detect smaller leaks, and may be unable to detect pinhole leaks. Additionally, the success (e.g., accuracy, precision) of a rarefaction wave leak detection system (LDS) may depend on the frequency and sensitivity of the sensor feedback and instrument measurements.

However, remote fiber optic sensing and rarefaction wave techniques have limitations regarding leak detection and localization. For example, when fiber optic sensing detects a leak event, it may report a relatively accurate leak location (e.g., within a few meters of accuracy), but it may be unable to physically interpret the size of the leak and the severity of the event. Additionally, fiber optic sensing techniques may raise a number of false alarms by mistaking other events (e.g., pigging events) as leak events, as the associated detection algorithm does not take into account physical measurements of the fluid within the pipeline, such as pressure and flow rate of the hydrocarbon fluid. Conversely, rarefaction wave techniques may result in relatively small numbers of false alarms with suitable processing and thresholding but depend on high frequency pressure measurements at both ends of the leak location (e.g., upstream and downstream from the leak location). Further, rarefaction wave techniques may be ineffective at detecting and localizing slow onset leaks, such as leaks associated with underground corrosion or gradual mechanical failure.

Accordingly, the present disclosure provides systems and methods to integrate fiber optics and rarefaction wave (e.g., negative pressure wave) techniques to identify and quantify leak events. A fiber optic cable may be installed along a pipeline to track fluid flow and noise, identify anomalies, and perform event classification, such as relatively accurate pipeline leak localization. Additionally, pressure sensors may be installed at discreate locations along the pipeline (e.g., every 30-kilometers, every 50-kilometers, at the inlet/outlet of pipeline components, etc.) to continuously measure pressure along the pipeline. When a leak occurs, the pressure may fall (e.g., by an amount ΔP). The pressure sensors may detect the change in pressure depending on the leak location (e.g., pressure sensors near the leak may detect a change, while pressure sensors a greater distance from the leak may not) and measurement frequency (e.g., if pressure measurements are only taken at certain times, the sensors may not measure the pressure at the time or near the time the leak occurs).

As discussed above, the fiber optic cable may identify a relatively accurate pipeline leak location, but may raise false alarms as it does not gather or interpret physical measurements of the fluid within the pipeline such as pressure and flowrate. Accordingly, the fiber optic cable may misidentify pigging events as leak events. Thus, the leak location identified by the fiber optic cable may be cross-validated using the pressure sensors and rarefaction wave techniques. For example, the leak location detected by the fiber optic cable and the time the leak was detected may be input into a rarefaction wave model, which may determine estimated times for pressure drops at nearby pressure measurement stations using acoustic speed calculations, and may validate the detected leak location by comparing the pressure trends at the pressure measurement stations before and after the estimated times. That is, the rarefaction wave model may determine when pressure drops are expected to occur at various pressure measurement stations for a given leak location, and may confirm the leak location detected by the fiber optic cables if expected pressure drops occur at expected times at the various pressure measurement stations. The greater number of pressure stations that observe the expected pressure drops, the greater confidence in the detected leak location. If none of the pressure stations near the detected leak location (e.g., within 30-kilometers, 50-kilometers, etc.) observe a pressure drop, the leak event may be resolved as a false alarm. Thus, the fiber optic cable may enable the detection of smaller leaks than rarefaction wave alone (e.g., leaks having a diameter of approximately 2% or less of the pipe diameter), and the rarefaction way may decrease the number of false alarms associated with fiber optic sensing.

With the foregoing in mind, FIG. 1 is a schematic view of a pipeline system 10 with a number of pipeline components 12 fluidly coupled via fluid conduits or pipes 14 for transporting production fluid (e.g., hydrocarbons, oil, natural gas, etc.). As discussed in further detail below, the pipeline system 10 uses a combination of feedback from fiber optics outside the fluid conduits or pipes 14 and rarefaction wave models based on sensor feedback inside the fluid conduits or pipes 14 to monitor and control operations of the pipeline system 10.

The pipeline system 10 may include any above-ground and/or buried configuration of the fluid conduits or pipes 14. In certain embodiments, the pipeline system 10 may be a buried transcontinental oil and gas transmission network. Each pipeline component may represent any suitable hardware component or system, such as one or more of: a well having a wellhead and a Christmas tree coupled to a subterranean reservoir, a substation, a power station, a pump or pump substation, a compressor or compressor substation, a valve, a fluid manifold, a fluid storage facility, a fluid processing facility, a refinery, or any combination thereof. While the illustrative embodiment includes five pipeline components 12, the pipeline system 10 may include additional or fewer pipeline components 12. Likewise, the pipeline system 10 may include additional or fewer pipes 14 (e.g., more or fewer subloops between pipeline components 12). The pipes 14 may be any suitable material (e.g., metal, plastic, composite, etc.), and may include features (e.g., changes in volume, bends, etc.) that affect properties of the production fluid (e.g., flowrate, temperature, pressure, etc.).

The pipeline system 10 may also include a computing system and/or controller 16. The controller 16 includes one or more processors 18 (e.g., processing circuitry), a memory 20, instructions 22 stored on the memory 20 and executable by the one or more processors 18, and communication circuitry 24. The pipeline system 10 may also include one or more sensors 26 coupled to the pipeline components 12 and/or at discrete points along the pipes 14 (e.g., every 30-kilometers, every 50-kilometers, and so forth), and communicatively coupled to the controller 16 via the communication circuitry 24. The sensors 26 may include temperature sensors, pressure sensors, flowrate sensors, water content sensors, fluid composition sensors, electrical load sensors, or any combination thereof. In certain embodiments, the sensors 26 may include additional sensors coupled along the pipes 14 (e.g., fiber optic cable installed along the exterior of the pipes 14). In certain embodiments, the controller 16 may be communicatively coupled to one or more of the pipeline components 12 as part of a supervisory control and data acquisition (SCADA) system. Accordingly, the controller 16 may monitor and adjust operations of the one or more pipeline components 12 based on sensor feedback from the sensors 26 and/or user inputs.

The controller 16 may execute instructions 22 to process and analyze sensor feedback from fiber optic cables (e.g., external feedback outside the pipes 14) to evaluate operational parameters (e.g., potential leaks) of the pipeline system 10, such that potential leaks may be precisely located along the pipeline system 10 (e.g., precise location within a distance of less than or equal to 1, 2, or 3 meters of any leaks). Further, acoustic and temperature measurements from the fiber optic cables may be processed using analytical workflows (e.g., dynamic simulation software, computer models) and machine learning techniques to classify the detected leak event as a digging event, a drilling event, an excavator event, a fiber break event, a pigging event, and like. Additionally, fiber optic sensor feedback may be processed to determine an event severity level, such as low, medium, or high severity. The severity level may be determined based on threshold analysis (e.g., comparing the acoustic and temperature measurements to one or more threshold values associated with past leak events of ranging severity), rather than based on direct physical measurements (e.g., pressure, flowrate) with direct physics implications. The severity level of the leak may indicate whether the leak warrants a warning alert or alarm, a scheduled inspection and/or maintenance, an adjustment to operation of the pipeline system 10 (e.g., reduce pressure and/or flowrate), a shutdown of operations (e.g., close valves), or any combination thereof, performed by the controller 16.

In certain embodiments, the controller 16 may execute instructions 22 including rarefaction wave computer models and/or dynamic simulation software (e.g., pipeline model) to model, simulate, or predict operations and various operating parameters (e.g., potential leaks) of the pipeline system 10 based on sensor feedback from the sensors 26 (e.g., measured pressure). For example, time data associated with measured pressure drops at various locations along the pipes 14 may be inputted into the rarefaction wave computer models, which may calculate a location of the leak based on the sensor feedback and speed of sound calculations. In some embodiments, the fiber optic sensing and rarefaction wave modeling may be integrated to provide cross-validated leak localization. For example, in some embodiments, a leak location and time detected by the fiber optic cables may be fed into the rarefaction wave models as a known input, such that the rarefaction wave model outputs expected time stamps for pressure drops at various discrete positions corresponding to one or more sensors 26 correlated with the detected leak event (e.g., location and time). The rarefaction wave models and/or dynamic simulation software may then compare the expected time stamps to pressure measurements from the one or more sensors 26. If the one or more sensors 26 measure corresponding pressure drops at the expected time stamps, the rarefaction wave models and/or dynamic simulation software may confirm the leak event detected by the fiber optic cables. If the one or more sensors 26 do not observe pressure drops at the expected time stamps, the rarefaction wave models and/or dynamic simulation software may flag the leak event detected by the fiber optic cables as a false alarm. Accordingly, the rarefaction wave models and/or dynamic simulation software may cross-validate the detected leak event from the fiber optic cables and associated analysis, thereby confirming the accuracy of the detected leak event. Additionally, performing speed of sound calculations to determine predicted time stamps of pressure drops for a given leak location may be less computationally intensive (e.g., less time consuming, reduced processing power requirements, etc.) than determining a predicted leak location from measured pressure drops at measured time intervals. Accordingly, the precise leak location acquired by the fiber optic cables may be used to improve the performance, efficiency, and accuracy of using the rarefaction wave models in leak detection systems.

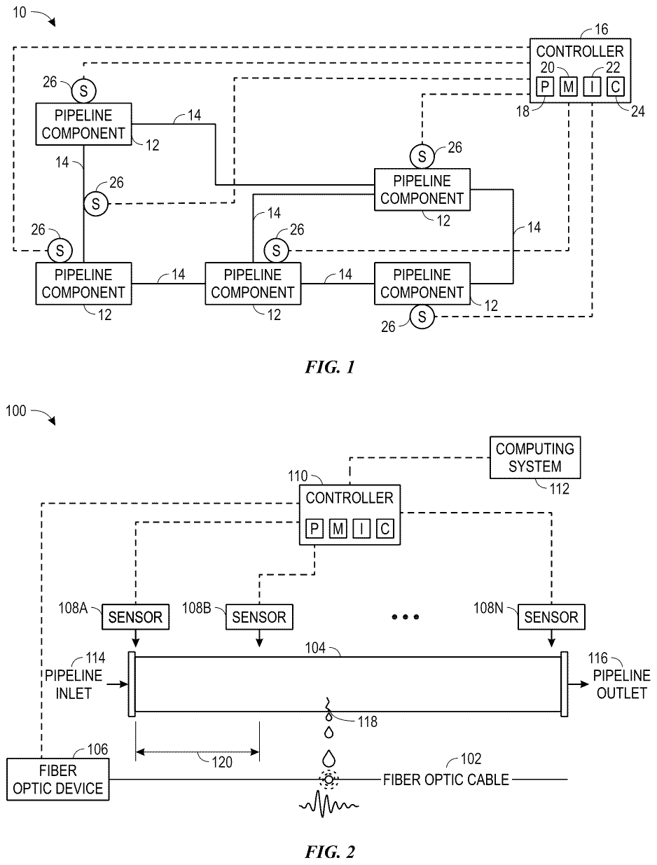

With the foregoing in mind, FIG. 2 is a schematic view of a pipeline monitoring system 100 that may be implemented in the pipeline system 10 of FIG. 1, or any other suitable pipeline network or portion of a pipeline network. As shown, the monitoring system 100 includes a fiber optic cable 102 installed along a pipeline 104 (e.g., fluid conduit or pipe 14 of pipeline system 10) and coupled to a fiber optic device 106, a number of pressure stations or pressure sensors 108a-n, a controller 110 (e.g., controller 16 in certain embodiments) communicatively coupled to the sensors 108a-n, the fiber optic device 106, and a computing system 112 (e.g., via wired or wireless connections, or a combination thereof). The controller 110 may include substantially the same components as discussed above regarding the controller 16 (e.g., a processor, a memory, instructions stored on the memory and executed by the processor, and communication circuitry). Additionally, the controller 110 may establish controls on a pressure, temperature, and flowrate at an inlet 114 and an outlet 116 of the pipeline 104, may share sensor feedback from the pressure sensors 108a-n, any other suitable sensors along the pipeline 104 (e.g., temperature, flowrate, etc. sensors), and the fiber optic device 106 with the computing system 112, and may adjust operations of one or more pipeline components (e.g., components 12) in response to the sensor feedback and/or user input.

The fiber optic cable 102 may be installed along the exterior of the pipeline 104. For example, as discussed above, the fiber optic cable 102 may be embedded or placed in close proximity to a material which is affected by the pressure of the production fluid (e.g., hydrocarbons, oil, natural gas, etc.), such as any suitable polymer, metal, ceramic, gel, or combination thereof, and the like. The material may be applied as a coating to the fiber optic cable 102, and may undergo a change such as swelling, shrinking, dissolving, or any other suitable reaction in response to the presence of the fluid. The change in the material may affect the fiber optic cable 102 by increasing or reducing strain on the fiber 102, or by causing a chemical reaction with the fiber 102 (e.g., resulting in a temperature change).

Further, the fiber optic cable 102 may be coupled to the fiber optic device 106. The fiber optic device 106 may act as a measurement device for fiber optic sensing, and may include laser sources, modulators, receivers and acquisition electronics, in conjunction with processing and memory circuitry to calculate the value of a measurement. Light may be sent through the fiber optic cable 102 by the fiber optic device 106 (e.g., via the laser sources), changes in stresses on the fiber optic cable 102 (e.g., from changes in the coating material) may be measured by measuring changes in the wavelength of the light returned by the fiber optic cable 102, the changes in the wavelength of the light may be used to calculate the temperature along the pipeline 104, and temperature anomalies can be correlated to the presence of a leak 118 in the pipeline 104. Additionally, changes in the intensity of wavelength-shifted light returned by the fiber optic cable 102 may provide insight into the strain on the fiber optic cable 102. For example, any suitable technique may be used to measure the change in stress and the corresponding changes in the optical characteristics of the fiber optic cable 102, such as optical frequency domain reflectometry, detection of change in attenuation or index of refraction of the fiber optic cable 102, optical time domain reflectometry (OTDR), frequency domain techniques, Brillouin, Raman or Rayleigh scattering, and the like. Accordingly, when pipeline leakage occurs and hydrocarbon fluid affects the coating material, the fiber optics cable 102 and fiber optic device 106 may detect acoustic and temperature anomalies associated with the leak 118. While one fiber optic device 106 is shown in FIG. 2, there may be a number of fiber optic devices deployed along the pipeline 104 (e.g., one at each 10, 20, 30, 40, 50, etc. kilometers) for fiber optic sensing.

Due to the continuous nature of the fiber optic cable 102 (e.g., the fiber optic cable 102 spans the entire length of the pipeline 104), the fiber optic cable 102 may be used to detect and pinpoint a relatively accurate location of the leak 118 (e.g., within a few meters of the true leak location). Additionally, the monitoring system 100 may classify the detected event (e.g., as a digging, drilling, excavator, fiber break, pigging, etc. event) and generate a general event severity level (e.g., low, medium, high) based on thresholds associated with anomaly levels by processing real time acoustic and temperature data from the fiber optic cable 102 and the fiber optic device 106 using sophisticated analytical workflows and machine learning techniques. However, the monitoring system 100 may generate false alarms based on the fiber optic cable 102 and fiber optic device 106 alone. Accordingly, the monitoring system 100 may include the pressure sensors 108a-n and the computing system 112 in order to perform rarefaction wave modeling to cross-validate the leak event localization from the fiber optic cable 102 and fiber optic device 106.

The computing system 112 may include substantially the same components as discussed above regarding the controller 16 (e.g., a processor, a memory, instructions stored on the memory and executed by the processor, and communication circuitry), as well as additional components, such as a user display (e.g., user interface). The computing system 112 may be any suitable computing device that is capable of communicating with other devices and processing data in accordance with the techniques described herein. For example, in certain embodiments, the computing system 112 may be a cloud-based computing system that includes a number of computers that may be connected through a real-time communication network, such as the Internet. In one embodiment, large-scale analysis operations may be distributed over the computers that make up the cloud-based computing system. It should be noted that the computing system 112 may also be implemented in a single computing device, such as a laptop, notebook, desktop, tablet, human-machine interface (HMI), or workstation computer, as well as a server type device or portable, communication type device, such as a cellular telephone and/or any other suitable computing device. While the illustrative embodiment includes the controller 110 and the computing system 112, certain embodiments may include a single controller (e.g., controller 110). In such embodiments, the controller may perform substantially the same processes as described above regarding the controller 110 as well as those described below regarding the computing system 112.

The computing system 112 may locally and/or remotely access and execute software packages for rarefaction wave modeling and/or calculations. For example, the computing system 112 may store the software packages as instructions on the memory and/or access the software packages via the communication circuitry and a real-time communication network, such as the Internet, and execute the software packages by the processor. During operation of the pipeline 104, the computing system 112 may receive sensor feedback from the fiber optic cable 102 and the fiber optic device 106 indicative of a detected leak, via the controller 110. For example, the computing system 112 may receive the determined leak location, leak event type, and general leak severity level from the controller 110 as derived using sensor feedback from the fiber optic cable 102 and the fiber optic device 106. Additionally, the computing system 112 may receive sensor feedback (e.g., pressure values) from the pressure sensors 108a-n continuously monitoring fluid pressure along the pipeline 104. While the illustrative embodiment shows three sensors 108a, 108b, and 108n, there may be any suitable number of pressure sensors 108 disposed between the pipeline inlet 114 and the pipeline outlet 116 of the monitored section of pipeline 104. For example, there may be pressure stations or pressure sensors 108 disposed at equally spaced, discrete locations along the pipeline 104. That is, there may be any suitable number of pressure sensors 108 along the pipeline 104 spaced a distance 120 from each other. For example, there may be a pressure station or pressure sensor 108 every 30-kilometers, every 50-kilometers, and the like.

Accordingly, the computing system 112 may perform rarefaction wave modeling on the sensor feedback from the fiber optic cable 102 and the fiber optic device 106 (e.g., using the detected leak location as an input) to determine expected time stamps associated with pressure drops propagating out from the detected leak, and may compare the expected time stamps to pressure behavior measured by the sensors 108a-n to determine whether the expected pressure drops occurred at expected locations (e.g., at the locations of some or all of the sensors 108a-n) and times from the detected leak event. If the computing system 112 determines that the expected pressure behavior was observed by the sensors 108a-n, the computing system 112 may confirm or validate the leak event detected by the fiber optic cable 102 and fiber optic device 106, and may raise a suitable alarm associated with the leak event (e.g., a maintenance alert for low-severity leaks, a shut down alert for high-severity leaks, etc.). If the computing system 112 determines that the expected pressure behavior was not observed by the sensors 108a-n, the computing system 112 may characterize the detected leak event as a false alarm and may disable any associated alarms triggered by the fiber optic cable 102 and the fiber optic device 106.

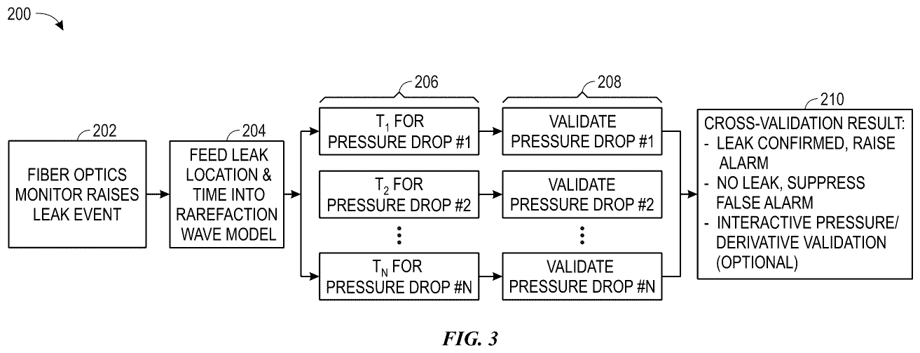

Therefore, the monitoring system 100 may integrate fiber optic sensing and rarefaction wave modeling to detect, quantify, and validate pipeline leaks. For example, the monitoring system 100 may detect and characterize a leak event using fiber optic sensing performed by the fiber optic cable 102 and the fiber optic device 106, may input the detect leak location into a rarefaction wave model and determine expected timestamps for expected pressure behavior at various locations near the detected leak location, and may gather pressure data at the expected timestamps from the expected locations to validate the detected leak event by comparing the measured pressure behavior to expected pressure behavior based on the detected leak. Additional details with regards to detecting, quantifying, and verifying pipeline leaks will be described with reference to FIG. 3.

With the foregoing in mind, FIG. 3 illustrates a block diagram of a process 200 for integrating fiber optics and rarefaction wave, in accordance with embodiments described herein. Although the following description of the process is described in a particular order, which represents a particular embodiment, it should be noted that the process 200 may be performed in any suitable order. Moreover, although the following description of process 200 is described as being performed by the monitoring system 100, it should be noted that the process 200 may be performed by any suitable computing device.

At block 202, the monitoring system 100 may detect and localize the leak 118 using fiber optic sensing (e.g., determine a location of the leak 118). Prior to initiating leak detection, the fiber optic cable 102 may be installed along the exterior of the pipeline 104 as a distributed acoustic sensing (DAS) system that enables continuous, real-time measurements along the length of the fiber optic cable 102, and thus, along the length of the pipeline 104. For example, the fiber optic device 106 may send a short pulse of light into the fiber optic cable, the pulse of light may return to the fiber optic device 106 as light backscatter after traveling through the fiber optic cable 102, and changes in the wavelength and/or intensity of the returned light may be used to calculate the temperature along the pipeline 104 and/or strain on the fiber optic cable 102. Further, the fiber optic device 106 may send light pulses through the fiber optic cable 102 repeatedly to generate a space-time image of acoustic events along the fiber optic cable 102. As discussed above, a coating may be applied to the fiber optic cable 102 that reacts to the presence of the production fluid (e.g., hydrocarbons, oil, natural gas, etc.). The reaction between the coating and the production fluid may affect the fiber optic cable 102 by increasing or reducing the strain on the fiber 102, or by causing a chemical reaction with the fiber 102 (e.g., resulting in a temperature change). Accordingly, when pipeline leakage occurs and the production fluid affects the coating material, the fiber optic cable 102 and fiber optic device 106 may detect acoustic and temperature anomalies associated with the leak.

Further, the real-time acoustic and temperature data from the fiber optic cable 102 may be processed with sophisticated analytical workflows and machine learning techniques to determine a detected event type, a general event severity, and an event location associated with the leak 118. The detected event type may be classified as digging, drilling, excavator, fiber break, pigging, and the like, event. The magnitude and location of the acoustic or temperature anomaly may be used, along with characteristics of the pipeline 104 (e.g., if the pipeline is part of an above-ground gather network or a buried transcontinental oil and gas transmission pipeline, etc.), to classify the event type. The general event severity may be broadly classified as low, medium, or high. This classification may not have direct physics implications (i.e., based on physics principals such as conservation equations and equations of state). Rather, the general event severity may be determined based on threshold values associated with the anomaly level (e.g., magnitude of the acoustic and/or temperature anomaly). The event location may be determined based on the space-time image of acoustic events along the fiber optic cable 102, and may be substantially accurate (e.g., within 1-2 meters of the true leak location).

At block 204, the monitoring system 100 may input the detected leak location and associated time into the rarefaction wave model. As discussed above, rarefaction wave, also referred to as acoustic, negative pressure, or expansion wave, is a leak detection method based on an analysis of pipeline pressure variations. For example, when the leak 118 occurs in the pipeline 104 it may cause a sudden pressure drop at its location, followed by a rapid re-pressurization. As a result, a low-pressure expansion wave may travel at the speed of sound through the production fluid (e.g., hydrocarbons, oil, natural gas, etc.), propagating from the leak in both directions (e.g., upstream and downstream from the leak) and traveling through or past one or more of the pressure sensors 108a-n at various positions along the pipeline 104, and thus at various distances away from the leak.

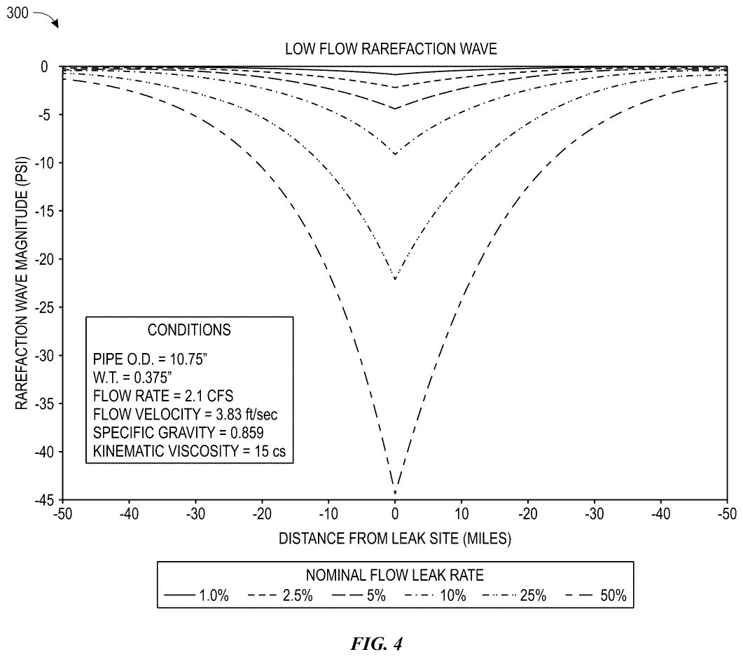

For example, FIG. 4 illustrates an example graph 300 of expected rarefaction wave magnitude upstream and downstream from the leak location for various nominal flow leak rates (e.g., leak rate as a fraction of the total fluid flow rate) with an outer pipe diameter of 10.75 inches, a pipe wall thickness of 0.375 inches, a total flow rate of 2.1 cubic feet per second (CFS), a flow velocity of 3.83 feet/second, a specific gravity of 0.859, and a kinematic viscosity of 15 centistokes (cs). As shown, the magnitude of the rarefaction wave may increase with the nominal leak flow rate and may propagate longer distances away from the leak location until dissipating. Accordingly, rarefaction wave leak detection methods may be more accurate at detecting high severity leaks.

In leak detection systems that only utilize a rarefaction wave model, a leak location may be determined by comparing measured pressure values at specific times and various locations along the pipeline to expected pressure values associated with a leak event, such as those shown in FIG. 4, according to speed of sound calculations. In contrast, embodiments of the present disclosure may input or feed the outputs of fiber optic sensing leak detection into the rarefaction wave model.

As discussed above, when the leak 118 occurs in the pipeline 104 it may cause a sudden pressure drop at its location, followed by a rapid re-pressurization, thereby causing a low-pressure expansion wave to propagate from the leak in both directions (e.g., upstream and downstream) at the speed of sound through the production fluid (e.g., hydrocarbons, oil, natural gas, etc.). The speed of sound in the pipeline 104 may be determined using Equation 1 below:

$$V = \sqrt{\frac{K}{ρ ( 1 + \frac{{KD}_{pipe}}{{E}_{pipe} {WT}_{pipe}} )}} \qquad ( 1 )$$

where: K is the bulk modulus or the inverse of fluid compressibility, ρ is average fluid density, Dₚᵢₚₑ is the diameter of the pipeline 104, Eₚᵢₚₑ is the material modulus of elasticity (e.g., Young's Modulus) of the pipeline 104, and WTₚᵢₚₑ is the wall thickness of the pipeline 104.

The speed of sound value calculated according to Equation 1 may be fixed for a given pipeline or fluid configuration. Accordingly, the speed of sound value for the pipeline 104 may be calculated by running controlled valve leak tests before the pipeline 104 begins normal operations (e.g., during an initial installation and calibration period for the pipeline 104, during a pigging or other maintenance operation). Varying temperature may impact the values of K (i.e., bulk modulus) and ρ (i.e., average fluid density), which may need to be accounted for and corrected for in standard rarefaction wave methods, as calculating an expected leak location using rarefaction wave is sensitive to the speed of sound value. However, in the context of the present disclosure with integrated fiber optics and rarefaction wave, the effects of varying temperature may not need to be corrected during the speed of sound calculations, as estimating expected times of pressure drops is not as sensitive to the speed of sound value as estimating an expected leak location. Thus, performing speed of sound calculations to determine predicted time stamps of pressure drops for a given leak location may be less computationally intensive (e.g., less time consuming, reduced processing power requirements, etc.) than determining a predicted leak location from measured pressure drops at measured time intervals. Accordingly, the precise leak location acquired by the fiber optic cables may be used to improve the performance, efficiency, and accuracy of using the rarefaction wave models in leak detection systems.

Additionally, or alternatively, the monitoring system 100 may derive a speed of sound value for performing rarefaction wave modeling using the fiber optic cable 102 and the fiber optic device 106. As discussed above, the fiber optic cable 102 may be installed as a distributed acoustic sensing (DAS) system, and the fiber optic device 106 may send light pulses through the fiber optic cable 102 repeatedly to generate a space-time image of acoustic events along the cable 102. A device known as a pig may be sent through the pipeline 104 to clean, inspect, or perform any other suitable maintenance activity on the pipeline 104 as part of a pigging operation. During the pigging operation, when the pig passes a weld joint in the pipeline 104, the pig may generate signatures of V-shapes on the DAS space-time image. The slope of the V-shape may indicate the speed of sound in the pipeline. Accordingly, the monitoring system 100 may utilizing fiber optic sensing and pigging operations to accurately calculate the speed of sound value of the pipeline 104.

At blocks 206, the monitoring system 100 may utilize the rarefaction wave model to estimate time stamps of expected pressure drops at nearby pressure stations 108 based on the inputted leak location and associated time. For example, the distance the rarefaction wave fronts are expected to move on either side (e.g., upstream and downstream) of the leak location at a time after the initial time (e.g., the time the leak is detected) may be calculated according to Equation 2 below:

$$Δ x ( t ) = ( t - {t}_{0} ) V \qquad ( 2 )$$

where: to is the time the leak was detected by the fiber optic sensing, t is some time after the leak was detected, V is the speed of sound value calculated using one of the methods described above, Δx(t) is the distance the rarefaction wave fronts will have moved downstream at time t, and −Δx(t) is the distance the rarefaction wave fronts will have moved upstream at time t.

The distance traveled by the rarefaction wave fronts may be expanded as the change in position of the wave fronts Δx(t)=x−x₀, where x is the location of the wave fronts at time t and x₀ is the leak location detected by the fiber optic sensing (e.g., the position of the wavefronts at t₀). Thus, Equation 2 may be rearranged to solve for pressure drop time stamps at nearby pressure stations (e.g., within 30-kilometers, within 50-kilometers, etc.), as shown by Equation 3 below:

$${t}_{i} = {t}_{0} + \frac{\vert {x}_{i} - {x}_{0} \vert}{V} , i = 1 , 2 , ... , N \qquad ( 3 )$$

where: N is the number of nearby pressure stations, x₁, x₂, . . . , x_{N} are the locations of the nearby pressure stations, to is the time the leak was detected by the fiber optic sensing, x₀ is the leak location detected by the fiber optic sensing, V is the speed of sound value, and t; is the expected pressure drop time stamp for pressure station i.

At blocks 208, the monitoring system 100 may validate whether or not expected pressure drops occur at the nearby pressure stations and expected time stamps calculated above. This evaluation may include statistically comparing pressure measurements before and after the expected time stamps. That is, the monitoring system 100 may compare pressure values between [tᵢ−Δt,tᵢ] vs. pressure values between [tᵢ,tᵢ±Δt], where Δt is a characteristic time period depending on the distance between the respective pressure station and the leak location. The characteristic time period may be on the order of a few seconds (e.g., 5 seconds, 10 seconds, 30 seconds, etc.), as the pipeline 104 may include components and controls to maintain a constant pressure within the pipeline which may counteract the pressure drops associated with the rarefaction wave. The monitoring system 100 may use a variety of methods to compare the pressure measurements before and after the expected time stamps to validate whether the expected pressure drops occur.

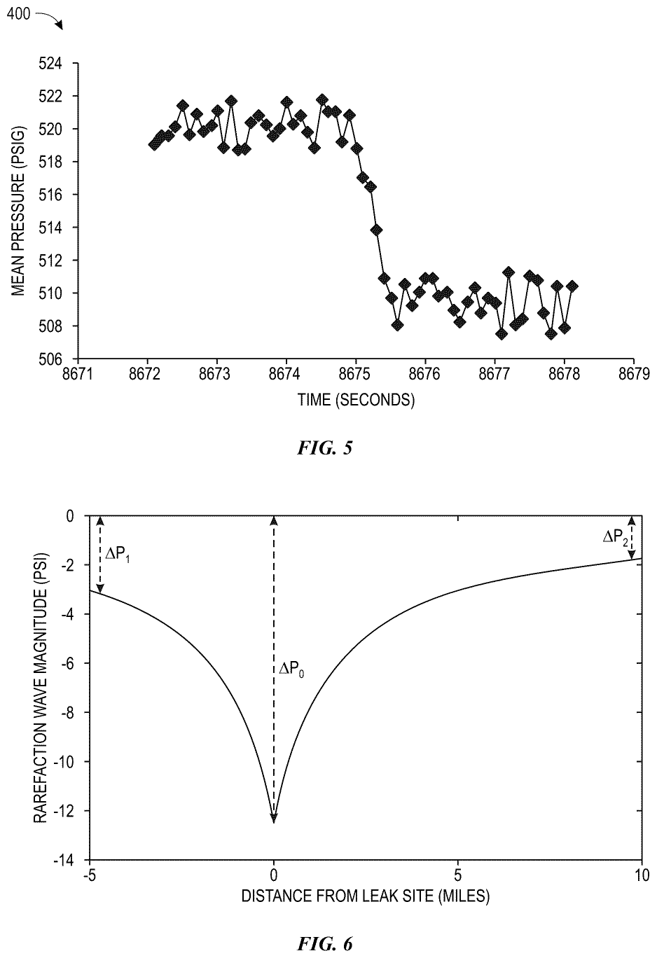

For example, the monitoring system 100 may compare the difference in average pressure before and after the expected time stamp to determine whether an expected pressure drop has occurred. If there is a significant difference in the average pressure (e.g., if the difference is larger than a standard deviation of pressure measurement noise), the monitoring system 100 may confirm that a leak occurred near the respective pressure station, thereby validating the expected leak location from the fiber optic sensing. FIG. 5 illustrates an example graph 400 of average pressure vs. time for a leak that occurred around t=8675 seconds. As shown in FIG. 5, there is a significant pressure drop (e.g., around 14 PSIG) from the time period directly before the leak occurred (e.g., from t=8672 seconds to 8675 seconds) to the time period directly after the leak occurred (e.g., from time 8675 seconds to 8678 seconds). Accordingly, if the monitoring system 100 detects similar pressure behavior to that shown in graph 400 (e.g., a pressure drop occurring around the expected time stamp), the monitoring system 100 may confirm the detected leak location.

Further, the monitoring system 100 may validate the expected pressure dops by computing a robust numerical derivative of the measured pressure curve. For example, the monitoring system 100 may use a Savitzky-Golay filter to compute a derivative of the measured pressure curve. When a spike exceeding a predetermined threshold occurs at the predicted pressure drop time stamp in the derivative curve, the monitoring system 100 may confirm the detected leak location from the fiber optic sensing. As this method compares expected behavior at a time and location to observed behavior at that time and location, rather than searching for behavior without an associated time and location, it may be more robust and efficient than standard rarefaction wave methods, in which a leak location is predicted based on measured pressure values.

Additionally, or alternatively, if there are at least two pressure measurements the monitoring system 100 may utilize the standard rarefaction wave detection method to find the pressure drop at time tᵢ (e.g., the expected pressure drop time stamp for pressure station i). Further, if the expected pressure drop time stamps follow the correlation shown below in Equation 4, the monitoring system 100 may validate the expected pressure drops:

$$\frac{1}{V} = \frac{{t}_{1} - {t}_{0}}{\vert {x}_{1} - {x}_{0} \vert} = … = \frac{{t}_{N} - {t}_{0}}{\vert {x}_{N} - {x}_{0} \vert} , i = 1 , 2 , ... , N \qquad ( 4 )$$

where: N is the number of nearby pressure stations, x₁, x₂, . . . , x_{N} are the locations of the nearby pressure stations, to is the time the leak was detected by the fiber optic sensing, x₀ is the leak location detected by the fiber optic sensing, V is the speed of sound value, and tᵢ is the expected pressure drop time stamp for pressure station i. This method may avoid the error caused in the calculation of the speed of sound (e.g., from varying temperatures effecting the bulk modulus and average fluid density) and provides N−1 constraints for validation purposes.

Rarefaction wave may be detected under certain leak types (e.g., some or all of digging, drilling, excavator, fiber break, pigging, etc. types). In these cases, the monitoring system 100 may additionally plot the dynamic behavior of pressure and flowrate within the pipeline 104 and statistically analyze if they reach a new steady state that deviates from the normal envelop (e.g., by more than standard deviation) to further validate and quantify the detected leak.

At block 210, the monitoring system may perform one or more actions based on whether or not the detected leak event was confirmed, identified as a false alarm, or inconclusive based on the rarefaction wave modeling. For example, if the monitoring system 100 detects a pressure drop or change at or near the expected time stamp calculated using Equation 3 above, the monitoring system 100 may confirm the leak event detected by the fiber optic cable 102 and fiber optic device 106, and may raise an alarm. For example, the monitoring system 100 may generate a notification on a user interface of a computing device associated with the pipeline 104 (e.g., computing system 112) indicative of a leak in the pipeline 104. The notification may include an indication of the location of the leak along the pipeline 104, as well as the predicted leak type (e.g., digging, drilling, excavator, fiber break, pigging) and general event severity level (e.g., low, medium, high) determined at block 202 using fiber optic sensing. Additionally, the notification may include one or more selectable options depending on the predicted leak type and general event severity level, such as an option to order a maintenance event or an option to trigger an emergency shut down operation of the pipeline 104. It should be noted that if multiple pressure drops are detected (e.g., by multiple sensors 108a-n), the magnitude of the pressure drop should decrease as the distance to the leak source increases. Additionally, the confidence that the leak event has occurred may increase with the number of pressure stations that experience the expected pressure drop behaviors at or near the predicted pressure drop time stamps.

Alternatively, if no statistically apparent (e.g., exceeding standard deviation) pressure drops are observed at or near the predicted leak location at the expected time stamps calculated according to Equation 3 above and the general leak severity level determined at block 202 is low or medium, the monitoring system 100 may categorize the leak event detected at block 202 as a false alarm and suppress or resolve any alarms or notifications indicative of a leak. Additionally, if statistically moderate to insignificant pressure drops (e.g., within or slightly exceeding standard deviation) are observed at or near the predicted leak location and the general leak severity is medium or high, the monitoring system 100 may present the pressure curve or pressure derivative curve (e.g., curves similar to those seen in FIGS. 3 and 4) within a user interface of a computing device associated with the pipeline 104 (e.g., computing system 112) to allow an operator to validate or resolve the leak event based on the observed pressure behaviors. In such cases, the flow conditions may not be suitable for the rarefaction wave, such as slow leaks caused by underground corrosion or slow mechanical failure, leading to the discrepancy between the fiber optic sensing and the rarefaction wave. Accordingly, rather than label such events as false alarms, the monitoring system 100 may prompt a human operator to review the measured pressure behavior and results from the fiber optic sensing and rarefaction wave modeling to determine whether or not to raise an alarm or categorize the event as a false alarm.

While it is not shown in FIG. 3, if the monitoring system 100 confirms the leak detected by the fiber optic sensing at block 210, the monitoring system 100 may perform additional calculations to estimate the leak rate and size. For example, if flowrate measurements are available at both ends of the leak (e.g., if one or more flowrate sensors are disposed upstream and downstream of the leak), the leak rate may be estimated based on mass balance calculations. If only pressure measurements are available (e.g., via pressure sensors 108a-n), a wave propagation estimation may be conducted to estimate the leak rate and size.

For example, the pressure wave magnitude at the leak location may be determined using Equation 5:

$$Δ {P}_{0} = - \frac{V {\dot{M}}_{leak}}{2 A} \qquad ( 5 )$$

where: A is the cross-sectional area of the pipeline 104, \dot{M}ₗₑₐₖ is the mass flowrate of the leak, and V is the speed of sound value. Thus, volumetric flowrate of the leak may be estimated according to Equation 6:

$${Q}_{leak} = - \frac{π {D}_{pipe}^{2} Δ {P}_{0}}{2 ρ V} \qquad ( 6 )$$

where: Dₚᵢₚₑ is the diameter of pipe, ΔP₀ is the pressure wave magnitude at the leak location, ρ is average fluid density, and V is the speed of sound value.

The pressure wave magnitude at the leak location, ΔP₀, is higher than the pressure wave magnitude at nearby pressure measurement points, ΔP₀, due to heat transfer and friction losses. The magnitude of the pressure wave is expected to reduce as the distance away from the leak location increases, as seen in FIG. 3. This wave reduction may be corrected by running leak tests or numerical simulations in advance (e.g., before a leak has been detected, during an initial installation and calibration period for the pipeline 104, during a pigging or other maintenance operation, etc.). Alternatively, when at least two pressure drops are detected (e.g., N≥2) a simple regression may be used to estimate ΔP₀ by assuming the inverse of the pressure wave magnitude reduces linearly away from the leak location, as shown in Equation 7 below:

$$\frac{1}{Δ {P}_{i}} = a \vert {x}_{i} - {x}_{0} \vert + \frac{1}{Δ {P}_{0}} , i = 1 , 2 , ... , N \qquad ( 7 )$$

This regression has N equations, where N is the number of nearby pressure stations that observed a pressure drop, and two unknowns, a and ΔP₀. Thus, the pressure wave magnitude at the leak location, ΔP₀, may be estimated using Equation 7 if two or more pressure stations observed a pressure drop. For example, FIG. 6 illustrates a graph 500 of using a regression with N=2 to estimate the pressure drop at the leak location.

Alternatively, an exponential model based on the continuity equation and momentum conservation may be used to estimate ΔP₀, as shown in Equation 8 below:

$$log Δ {P}_{i} = a \vert {x}_{i} - {x}_{0} \vert + log Δ {P}_{0} , i = 1 , 2 , ... , N \qquad ( 8 )$$

As with Equation 7 above, this exponential model has N equations, where N is the number of nearby pressure stations that observed a pressure drop, and two unknowns, a and ΔP₀. Thus, the pressure wave magnitude at the leak location, ΔP₀, may be estimated using Equation 8 if two or more pressure stations observed a pressure drop.

The monitoring system 100 may use the Bernoulli equation for liquid to quantitatively estimate the leak size, as the leak rate is proportional to the square of the leak diameter. Equation 9 gives the Bernoulli equation for liquid:

$${Q}_{leak} = - \frac{π {D}_{leak}^{2} C}{4} \sqrt{\frac{2 ( {P}_{0} - {P}_{0}^{out} )}{ρ}} \qquad ( 9 )$$

where: C is the discharge coefficient, P₀ is the pressure inside the pipeline leak,

$${P}_{0}^{out}$$

is the pressure outside of the pipeline leak, Dₗₑₐₖ is the diameter of leak, and ρ is average fluid density. P₀ may be estimated using ΔP₀, which may be estimated using Equation 7 or Equation 8 above. Thus, the monitoring system 100 may use pressure measurements to qualitatively estimate the leak rate and size, which may be used to improve the accuracy of the leak event severity level determined at block 202 using fiber optic sensing. That is, the monitoring system 100 may use physical measurements of properties within the pipeline 104 to recalculate or validate the leak event severity level, which is initially calculated based on threshold analysis (e.g., comparing the acoustic and temperature measurements to one or more threshold values associated with past leak events of ranging severities) rather than based on direct physical measurements with direct physics implications.

Thus, the process 200 may be used to integrate fiber optics and rarefaction wave for leak detection and quantification. As discussed above, rarefaction wave may be used to cross-validate a leak detected through fiber optic sensing, which may reduce the number of false alarms raised by the fiber optic sensing. Additionally, the fiber optic sensing may be capable of detecting smaller and more gradual leak events than the rarefaction wave, and inputting the results of the fiber optic sensing into the rarefaction wave model to solve for expected pressure drop time stamps based on an inputted leak location and initial time may be more efficient and accurate than standard rarefaction wave methods which estimate leak location based on observed pressure behaviors. Therefore, integrating fiber optics and rarefaction wave may provide improved leak detection, with fewer false alarms, a wider range of detectable leak event types, and improved accuracy and efficiency.

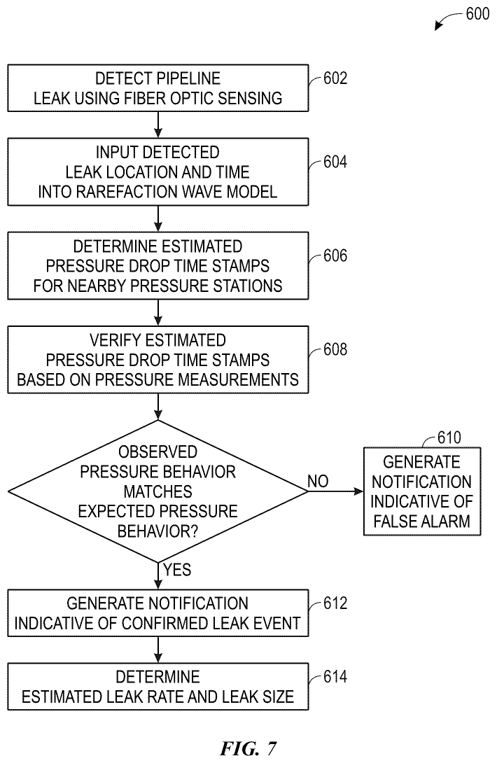

FIG. 7 is a flow chart of a workflow 600 for detecting and quantifying a pipeline leak event, such as within the pipeline system 10 of FIG. 1 and/or the pipeline 104 of FIG. 2. Although the following description of the workflow 600 is described in a particular order, which represents a particular embodiment, it should be noted that the workflow may be performed in any suitable order. Moreover, it should be noted that the workflow 600 may be performed by any suitable computing device (e.g., controller 16, controller 110, computing system 112) or combination of computing devices, associated with a respective pipeline.

At block 602, the workflow 600 may detect a pipeline leak using fiber optic sensing. This may include substantially the same techniques as described above regarding block 202 of FIG. 3. That is, a fiber optic device may send light pulses through a fiber optic cable installed as a distributed acoustic sensing (DAS) system along an exterior of a pipeline to measure real-time temperature and strain on the fiber and generate a space-time image of acoustic events along the fiber optic cable, and thus along the pipeline. The real-time acoustic and temperature data from the fiber optic cable may be processed with sophisticated analytical workflows and machine learning techniques to determine a detected event type (e.g., digging, drilling, excavator, fiber break, pigging), a general event severity level (e.g., low, medium, high), and an event location and initial time associated with the leak.

At block 604, the workflow 600 may input the detected leak location and associated time determined at block 602 into a rarefaction wave model. Accordingly, at block 606, the workflow 600 may determine estimated time stamps of expected pressure drops at pressure stations near the detected leak location (e.g., within 30-kilometers, within 50-kilometers, etc.) using the detected leak location and associated time and rarefaction wave (e.g., some or all of Equations 1-3 described above).

At block 608, the workflow 600 may verify the estimated pressure drop time stamps based on pressure measurements taken at pressure stations near the detected leak location. For example, as described above regarding block 208 of FIG. 3, the workflow 600 may statistically compare average pressure before and after the estimated time stamps to determine whether the expected pressure drops occurred, compute a robust numerical derivative of the measured pressure curve (e.g., using a Savitzky-Golay filter), and/or perform standard rarefaction wave calculations if at least two pressure measurements are available according to Equation 4.

If the observed pressure behavior does not substantially match expected pressure behavior for a leak at the detected leak event location, the workflow 600 may proceed to block 610 and generate a notification indicative of a false alarm and/or an inconclusive leak. For example, if at block 202, the fiber optic sensing determined that the leak event severity is low or medium and no statistically apparent (e.g., exceeding standard deviation) pressure drops are observed at or near the predicted leak location at the expected time stamps, the workflow 600 may categorize the leak event as a false alarm and resolve or dismiss any tentative alarms generated at block 202 from the fiber optic sensing. In such a case, the notification indicative of a false alarm may indicate that the fiber optic cable and fiber optic device(s) generated a false alarm and may prompt an operator to schedule an inspection or other maintenance event for the fiber optic cable and device(s).

Additionally, if at block 202, the fiber optic sensing determined that the leak severity is medium or high and statistically moderate to insignificant pressure drops (e.g., within or slightly exceeding standard deviation) are observed at or near the predicted leak location, the workflow 600 may present a notification indicative of an inconclusive leak event including a measured pressure curve or pressure derivative curve (e.g., curves similar to those seen in FIGS. 3 and 4) to allow an operator to validate or resolve the leak event based on the observed pressure behaviors. In such cases, the flow conditions may not be suitable for the rarefaction wave, such as slow leaks caused by underground corrosion or slow mechanical failure, leading to the discrepancy between the fiber optic sensing and the rarefaction wave. Accordingly, rather than label such events as false alarms, the workflow 600 may prompt a human operator to review the measured pressure behavior and results from the fiber optic sensing and rarefaction wave modeling to determine whether or not to raise an alarm or categorize the event as a false alarm.

Alternatively, if the observed pressure behavior substantially matches expected pressure behavior for a leak at the detected leak event location, the workflow 600 may proceed to block 612 and generate a notification indicative of a confirmed leak event. For example, if the workflow 600 detects a pressure drop or change at or near the expected time stamp calculated using Equation 3 above, the workflow 600 may confirm the leak event detected by the fiber optic sensing and raise an alarm. For example, the workflow 600 may generate a notification on a user interface of a computing device associated with the pipeline indicative of a leak in the pipeline. The notification may include an indication of the location of the leak along the pipeline, as well as the predicted leak type (e.g., digging, drilling, excavator, fiber break, pigging) and general event severity level (e.g., low, medium, high) determined at block 602 using fiber optic sensing. Additionally, the notification may include one or more selectable options depending on the predicted leak type and general event severity level, such as an option to order a maintenance event or an option to trigger an emergency shut down operation of the pipeline.

At block 614, after the workflow 600 confirms the leak event detected at block 602, the workflow 600 may determine an estimated leak rate and/or leak size. For example, if flowrate measurements are available at both ends of the leak (e.g., if one or more flowrate sensors are disposed upstream and downstream of the leak), the leak rate may be estimated based on mass balance calculations. If only pressure measurements are available, a wave propagation estimation may be conducted to estimate the leak rate and size according to some or all of Equations 5-9. That is, the pressure wave magnitude at the leak location may be estimated according to Equation 7 and/or Equation 8, which may be used to determine an estimated pressure inside the pipeline leak. The estimated pressure inside the pipeline leak may then be used with Equation 9 (e.g., Bernoulli equation for liquid) to quantitatively estimate the leak size. The estimated leak size may be used to verify and/or recalculate the leak event severity score from block 602.

The technical effect of the disclosed embodiments include integrating fiber optics and rarefaction wave to identify and quantify pipeline leak events, thereby improving response time for resolving pipeline leak events while reducing the number of false alarms. Specifically, a fiber optic cable may be installed along a pipeline to gather real-time temperature and acoustic measurements, identify anomalies, and perform leak event classification, such as relatively accurate pipeline leak localization. Subsequently, rarefaction wave may be used to cross-validate the detected leak event. The rarefaction wave may determine estimated pressure drop time stamps for locations near the detected leak location based on the detected location and associated time from the fiber optic sensing and may observe pressure behaviors before and after the estimated pressure drop time stamps to determine whether or not the expected pressure behavior occurs. The fiber optic cable may enable the detection of smaller and/or more gradual leaks than rarefaction wave alone (e.g., leaks having a diameter ˜2% or less of the pipe diameter) while reducing the computational complexity of the rarefaction wave, and the rarefaction wave may decrease the number of false alarms associated with the fiber optic sensing. Accordingly, the integrated fiber optics and rarefaction wave leak detection and quantification methods may improve the accuracy and efficiency of pipeline leak detection.

The subject matter described in detail above may be defined by one or more clauses, as set forth below.

A system includes a processor, a memory, and instructions stored on the memory and executable by the processor to: receive, from a fiber optic cable extending along a fluid conduit, an indication of a leak event; receive, from one or more sensors, measured pressure values of a fluid flow along the conduit; determine one or more estimated time stamps associated with one or more expected pressure changes at one or more locations along the fluid conduit based on the indication of the leak event and a rarefaction wave model; compare the measured pressure values from the one or more sensors to expected pressure values at the one or more locations along the fluid conduit to verify the one or more estimated time stamps; and generate a notification based on the comparison of the measured pressure values and the expected pressure values.

The system of the proceeding clause, wherein the indication of the leak event comprises a leak location and an initial time associated with the leak event.

The system of any proceeding clause, wherein the processor is configured to determine a leak type and a leak severity based on the indication of the leak event.

The system of any proceeding clause, wherein the fiber optic cable is configured to couple to an exterior of the fluid conduit.

The system of any proceeding clause, wherein the one or more sensors are configured to measure a pressure, a temperature, a flow rate, or a combination thereof, of the fluid flow along the conduit.

The system of any proceeding clause, wherein the measured pressure values comprise a first set of one or more pressure values measured at one or more time periods before the one or more estimated time stamps and a second set of one or more pressure values at one or more time periods after the one or more expected time stamps.

The system of any proceeding clause, wherein the processor is configured to compare the first set of one or more pressure values to the second set of one or more pressure values to determine whether the one or more expected pressure changes occur at the one or more estimated time stamps.

The system of any proceeding clause, wherein the notification comprises an indication of a confirmed leak event based on a determination that the one or more expected pressure changes occur at the one or more estimated time stamps.

The system of any proceeding clause, wherein the processor is configured to adjust operations of one or more components coupled to the fluid conduit based on a determination that the one or more expected pressure changes occur at the one or more estimated time stamps.

The system of any proceeding clause, wherein the notification comprises an indication of a false alarm based on a determination that the one or more expected pressure changes do not occur at the one or more estimated time stamps.

The system of any proceeding clause, wherein the processor is configured to determine an estimated leak flow rate, an estimated leak size, or both based on measurements of one or more parameters from the one or more sensors.

A method includes detecting one or more parameters of a leak event via a fiber optic cable extending along a fluid conduit, and determining an estimated time stamp associated with an expected pressure change for one or more locations along the fluid conduit based on the one or more parameters and a rarefaction wave model. The method also includes receiving one or more measured pressure values at the one or more locations along the fluid conduit, determining whether the expected pressure change occurs at the estimated time stamp for each of the one or more locations by comparing the one or more measured pressure values to one or more expected pressure values, and generating a notification indicative of one or more characteristics of the leak event based on the comparison of the one or more measured pressure values and the one or more expected pressure values.

The method of the proceeding clause, wherein the one or more parameters comprises a location and a time of the leak event.

The method of any proceeding clause, wherein the one or more measured pressure values comprise a first pressure value measured at a time before the estimated time stamp and a second pressure value measured at a time after the estimated time stamp for each of the one or more locations.

The method of any proceeding clause, wherein the one or more characteristics of the leak event comprises a leak location, a leak type, a leak severity, or a combination thereof, based on the one or more measured pressure values substantially matching the one or more expected pressure values.

The method of any proceeding clause, wherein the one or more locations correspond to one or more pressure sensors located along the fluid conduit, and wherein the one or more measured pressure values are received from the one or more pressure sensors.

The method of any proceeding clause, wherein the one or more locations corresponds to a first pressure sensor located less than or equal to 50 kilometers upstream from a location of the leak event, a second pressure sensor located less than or equal to 50 kilometers downstream from the location of the leak event, or a combination thereof.

A non-transitory, tangible, computer readable medium including instructions that, when executed by a processor, causes the processor to perform operations comprising: detecting one or more parameters of a leak event via a fiber optic cable extending along a fluid conduit, determining an estimated time stamp associated with an expected pressure change for one or more locations along the fluid conduit within a threshold distance from the leak event based on the one or more parameters and a rarefaction wave model, determining whether the excepted pressure change occurs at the estimated time stamp for each of the one or more locations along the fluid conduit based on a comparison between one or more measured pressure values at the one or more locations to one or more expected pressure values at the one or more locations, and generating a notification indicative of one or more characteristics of the leak event based on the comparison between the one or more measured pressure values at the one or more locations to the one or more expected pressure values at the one or more locations.

The computer readable medium of the proceeding clause, wherein the one or more parameters of the leak event comprises a location and a time of the leak event.

The computer readable medium of any proceeding clause, wherein the operations comprise: in response to the one or more measured pressure values at the one or more locations substantially matching the one or more expected pressure values at the one or more locations, generating an alert indicative of the leak event, adjusting operations of one or more components along the fluid conduit, or a combination thereof, and in response to the one or more measured pressure values at the one or more locations not substantially matching the one or more expected pressure values at the one or more locations, generating an alert categorizing the leak event as a false alarm.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A system, comprising:
a processor, a memory, and instructions stored on the memory and executable by the processor to:
receive, from a fiber optic cable extending along a fluid conduit, an indication of a leak event;
receive, from one or more sensors, measured pressure values of a fluid flow along the conduit;
determine one or more estimated time stamps associated with one or more expected pressure changes at one or more locations along the fluid conduit based on the indication of the leak event and a rarefaction wave model;
compare the measured pressure values from the one or more sensors to expected pressure values at the one or more locations along the fluid conduit to verify the one or more estimated time stamps; and
generate a notification based on the comparison of the measured pressure values and the expected pressure values.

2. The system of claim 1, wherein the indication of the leak event comprises a leak location and an initial time associated with the leak event.

3. The system of claim 1, wherein the processor is configured to determine a leak type and a leak severity based on the indication of the leak event.

4. The system of claim 1, wherein the fiber optic cable is configured to couple to an exterior of the fluid conduit.

5. The system of claim 1, wherein the one or more sensors are configured to measure a pressure, a temperature, a flow rate, or a combination thereof, of the fluid flow along the conduit.

6. The system of claim 1, wherein the measured pressure values comprise a first set of one or more pressure values measured at one or more time periods before the one or more estimated time stamps and a second set of one or more pressure values at one or more time periods after the one or more expected time stamps.

7. The system of claim 6, wherein the processor is configured to compare the first set of one or more pressure values to the second set of one or more pressure values to determine whether the one or more expected pressure changes occur at the one or more estimated time stamps.

8. The system of claim 7, wherein the notification comprises an indication of a confirmed leak event based on a determination that the one or more expected pressure changes occur at the one or more estimated time stamps.

9. The system of claim 7, wherein the processor is configured to adjust operations of one or more components coupled to the fluid conduit based on a determination that the one or more expected pressure changes occur at the one or more estimated time stamps.

10. The system of claim 7, wherein the notification comprises an indication of a false alarm based on a determination that the one or more expected pressure changes do not occur at the one or more estimated time stamps.

11. The system of claim 1, wherein the processor is configured to determine an estimated leak flow rate, an estimated leak size, or both based on measurements of one or more parameters from the one or more sensors.

12. A method, comprising:
detecting one or more parameters of a leak event via a fiber optic cable extending along a fluid conduit;
determining an estimated time stamp associated with an expected pressure change for one or more locations along the fluid conduit based on the one or more parameters and a rarefaction wave model;
receiving one or more measured pressure values at the one or more locations along the fluid conduit;
determining whether the expected pressure change occurs at the estimated time stamp for each of the one or more locations by comparing the one or more measured pressure values to one or more expected pressure values; and
generating a notification indicative of one or more characteristics of the leak event based on the comparison of the one or more measured pressure values and the one or more expected pressure values.

13. The method of claim 12, wherein the one or more parameters comprises a location and a time of the leak event.

14. The method of claim 12, wherein the one or more measured pressure values comprise a first pressure value measured at a time before the estimated time stamp and a second pressure value measured at a time after the estimated time stamp for each of the one or more locations.

15. The method of claim 12, wherein the one or more characteristics of the leak event comprises a leak location, a leak type, a leak severity, or a combination thereof, based on the one or more measured pressure values substantially matching the one or more expected pressure values.

16. The method of claim 12, wherein the one or more locations correspond to one or more pressure sensors located along the fluid conduit, and wherein the one or more measured pressure values are received from the one or more pressure sensors.

17. The method of claim 16, wherein the one or more locations corresponds to a first pressure sensor located less than or equal to 50 kilometers upstream from a location of the leak event, a second pressure sensor located less than or equal to 50 kilometers downstream from the location of the leak event, or a combination thereof.

18. A non-transitory, tangible, computer readable medium comprising instructions that, when executed by a processor, causes the processor to perform operations comprising:
detecting one or more parameters of a leak event via a fiber optic cable extending along a fluid conduit;
determining an estimated time stamp associated with an expected pressure change for one or more locations along the fluid conduit within a threshold distance from the leak event based on the one or more parameters and a rarefaction wave model;
determining whether the excepted pressure change occurs at the estimated time stamp for each of the one or more locations along the fluid conduit based on a comparison between one or more measured pressure values at the one or more locations to one or more expected pressure values at the one or more locations; and
generating a notification indicative of one or more characteristics of the leak event based on the comparison between the one or more measured pressure values at the one or more locations to the one or more expected pressure values at the one or more locations.

19. The computer readable medium of claim 18, wherein the one or more parameters of the leak event comprises a location and a time of the leak event.

20. The computer readable medium of claim 18, wherein the operations comprise:
in response to the one or more measured pressure values at the one or more locations substantially matching the one or more expected pressure values at the one or more locations, generating an alert indicative of the leak event, adjusting operations of one or more components along the fluid conduit, or a combination thereof; and
in response to the one or more measured pressure values at the one or more locations not substantially matching the one or more expected pressure values at the one or more locations, generating an alert categorizing the leak event as a false alarm.
